(19) United States
(12) Patent Application Publication
(10) Pub. No.: US 2018/0162219 A1
(43) Pub. Date: Jun. 14, 2018

(54) DEVICE FOR OPENING AND CLOSING FUEL TANK INLET COVER OF VEHICLE

(71) Applicant: NIFCO KOREA INC., Asan-si (KR)

(72) Inventors: Young Gook LEE, Asan-si (KR); Do Young KIM, Asan-si (KR)

(21) Appl. No.: 15/889,759

(22) Filed: Feb. 6, 2018

Related U.S. Application Data
(63) Continuation-in-part of application No. PCT/KR2016/008854, filed on Aug. 11, 2016.

(30) Foreign Application Priority Data
Aug. 11, 2015 (KR) 10-2015-0113379

(51) Int. Cl. B60K 15/05; F16H 19/02; E05F 15/614

(52) U.S. Cl. CPC B60K 15/05; F16H 19/02; E05F 15/614; B60K 2015/0515; B60K 2015/053; E05Y 2201/722; B60K 2015/0576; B60K 2015/0584; E05Y 2900/534; E05Y 2201/704; E05Y 2201/712; B60K 2015/0538

(57) ABSTRACT

A device for opening and closing a fuel tank inlet cover for a vehicle can be easily assembled without the influence of a working space. The device includes a cover provided to a cap member having a fuel tank inlet so as to rotate with respect to a hinge, a push-lift provided such that an upper end portion thereof is lifted or lowered with respect to a through hole, which is formed in a coupling rib of the cover so as to be inserted into or withdrawn from the through hole, a lock rod for moving forward or backward to one side or the other side such that the push-lift is locked or unlocked, and an actuator for enabling the lock rod to move forward or backward in one or the other direction.

### CROSS-REFERENCE TO RELATED APPLICATION

This is a continuation in part application of PCT/KR2016/008854 filed on Aug. 11, 2016, which claims priority of Korean Patent Application No. 10-2015-0113379 filed on Aug. 11, 2015, the disclosure of which is incorporated herein.

### TECHNICAL FIELD

The present invention relates to a device for opening and closing a fuel tank inlet cover for a vehicle and, more specifically, to a device for opening and closing a fuel tank inlet cover for a vehicle so as to lock or unlock the fuel tank inlet cover, which can be easily assembled without the influence of a working space.

### BACKGROUND ART

In general, a cover for a fuel tank inlet is provided to a side surface of a vehicle so as to open or close the fuel tank inlet while being locked or unlocked by a device for opening and closing a fuel tank inlet cover.

Herein, referring to FIG. 1, a prior art device A for opening and closing a fuel tank inlet cover for a vehicle includes a cover 10 provided to a cap member 20, which has a fuel tank inlet 21, so as to rotate with respect to a hinge 30, a push-lift 40 provided to a through hole 11a, which is formed in a coupling rib 11 of the cover 10, such that one side end portion of the push-lift 40 can be inserted into or withdrawn from the through hole 11a, and an actuator 50 for enabling the push-lift 40 to be inserted into or withdrawn from the through hole 11a while moving forwards or backwards in one side or the other side direction.

According to such a prior art device A for opening and closing a fuel tank inlet cover for a vehicle, the push-lift 40 is inserted into or withdrawn from the through hole 11a, which is formed in the coupling rib 11 of the cover 10, by slidingly moving in one side or the other side direction according to the operation state of the actuator, thereby locking or unlocking the cover 10.

The prior art device A for opening and closing a fuel tank inlet cover for a vehicle has, however, a problem that a vehicle has to be developed in consideration of an additional operation space for mounting the device A for opening and closing a fuel tank inlet cover for a vehicle from the design phase of the vehicle since the push-lift 40 to be inserted into or withdrawn from the through hole 11a of the coupling rib 11 is directly coupled to the actuator 50.

In addition, the device A for opening and closing a fuel tank inlet cover for a vehicle has another problem that the development and manufacturing of vehicles incur huge expenses since the device A for opening and closing a fuel tank inlet cover for a vehicle has to be respectively manufactured and provided according to the kinds of the vehicles.

### PRIOR ART DOCUMENT

### Patent Document

Patent Document 1: Korean Reg. Patent No. 10-0828419

### DISCLOSURE OF INVENTION

### Technical Problem

The present invention has been carried out to solve the foregoing problems occurring in the prior arts, and it is an objective of the present invention to provide a device for opening and closing a fuel tank inlet cover for a vehicle, which can be easily assembled without the influence of a working space during the provision thereof with respect to a vehicle and ensure the common use of parts, thereby saving the manufacturing costs in the development and production of vehicles.

### Solution to Problem

To accomplish the above objective, a device for opening and closing a fuel tank inlet cover for a vehicle, according to the present invention, includes a cover provided to a cap member having a fuel tank inlet so as to rotate with respect to a hinge, a push-lift provided such that an upper end portion thereof is lifted or lowered with respect to a through hole, which is formed in a coupling rib of the cover, so as to be inserted into or withdrawn from the through hole, a lock rod for moving forwards or backwards to one side or the other side such that the push-lift is lifted or lowered so as to be locked or unlocked, and an actuator for enabling the lock rod to move forwards or backwards in one side or the other side direction.

Meanwhile, the actuator may include a motor provided to the inside of the case so as to operate therein, a worm gear for rotating in one side or the other side direction according to the operation direction of the motor, a worm wheel gear for rotating in one side or the other side direction by the rotation force of the worm gear so as to transmit the rotation force, and a lock gear for receiving the rotation force of the worm gear from the worm wheel gear so as to move to one side or the other side.

In addition, the lock gear has a rack gear part, which is formed at one side portion so as to be engaged with the worm wheel gear, and a coupling part, which is formed at the other side end portion so as to be engaged with one side end portion of the lock rod.

Meanwhile, an insertion protrusion is formed to be protruded on the other side end portion of the lock rod, of which one side portion is coupled with the coupling part of the lock gear, and an exit hole is formed in the push-lift so as to carry out the locking or unlocking according to the insertion or withdrawal state of the insertion protrusion.

### Advantageous Effects of Invention

According to the present invention, during the assembling of a vehicle, the device for opening and closing a fuel tank inlet cover, which locks or unlocks a fuel tank inlet cover, is provided in such a manner that the position of the actuator is moved to a position where an operation space is sufficiently secured and, in such a state, the actuator and the push-lift are connected to each other by the lock rod.

Further, in the development of vehicles, there is no need to differently manufacture each device for opening and closing a fuel tank inlet cover, which is appropriate for each kind of the vehicles.

In addition, it is possible to solve the inconvenience involved in the design phase of vehicles in consideration of the mounting space for the device for opening and closing a fuel tank inlet cover and reduce the manufacturing costs in the manufacturing of vehicles since the common use of parts can be achieved.

### BRIEF DESCRIPTION OF DRAWINGS

FIG. 1 is a block diagram for showing a prior art device for opening and closing a fuel tank inlet cover for a vehicle.

FIG. 2 is a perspective view for showing a device for opening and closing a fuel tank inlet cover for a vehicle according to the present invention.

FIG. 3 is an exploded perspective view for showing the construction of the device for opening and closing a fuel tank inlet cover for a vehicle according to the present invention.

FIG. 4 is a schematic view for showing the device for opening and closing a fuel tank inlet cover for a vehicle, according to the present invention, in a state, in which the device is provided to a cap member.

FIG. 5 is a perspective view for showing the device for opening and closing a fuel tank inlet cover for a vehicle, according to the present invention, in the state, in which the device is provided to the cap member.

FIG. 6 is a perspective view for showing a push-lift for the device for opening and closing a fuel tank inlet cover for a vehicle according to the present invention.

FIG. 7 is a rear view of an inlet cover of a fuel tank.

FIG. 8(a) is a side view of a push-lift in a lower position, and FIG. 8(a) is a side view of the push-lift in an upper position.

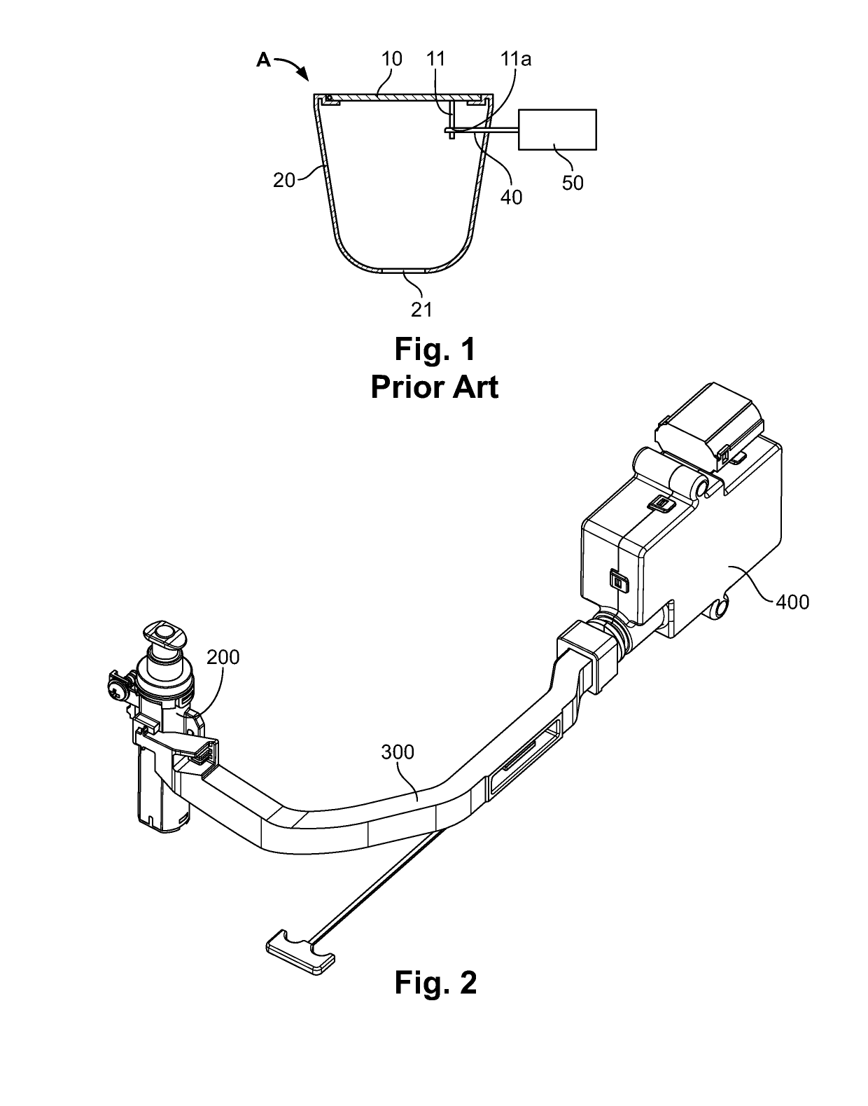

### BEST MODE FOR CARRYING OUT THE INVENTION

Hereinafter, the technical features of the present invention will be described in detailed with reference to the accompanying drawings.

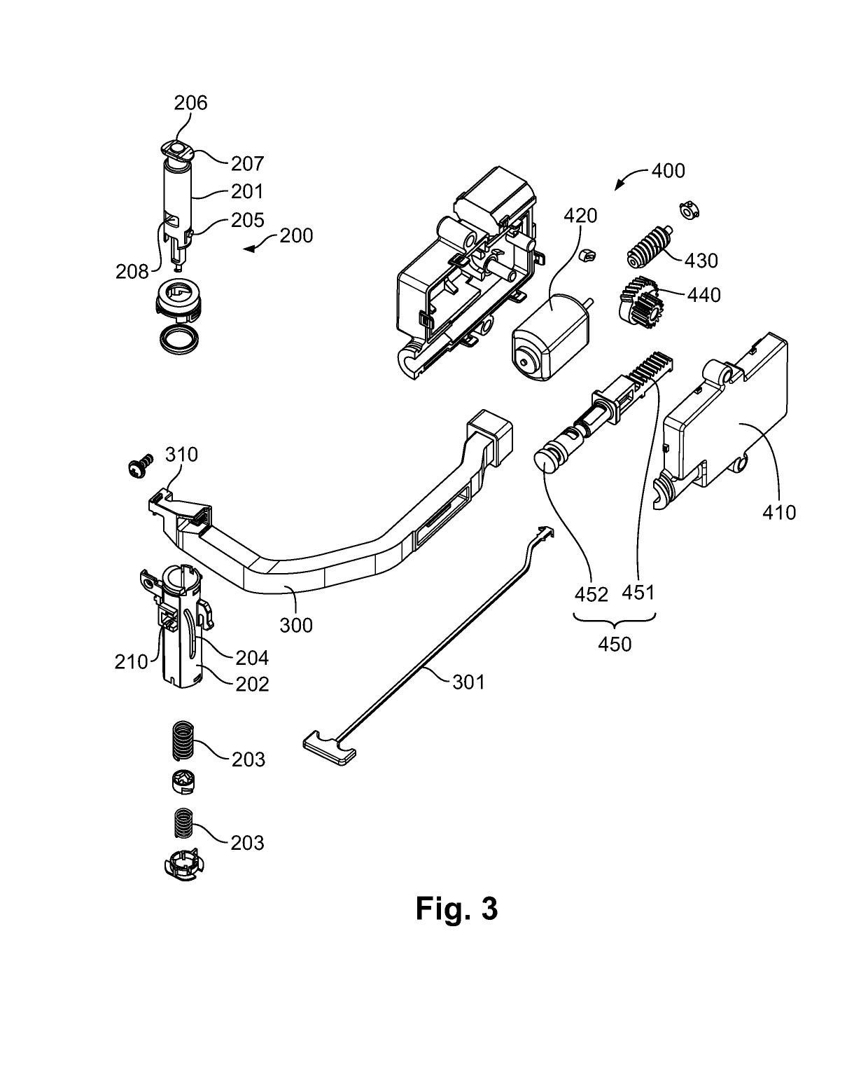

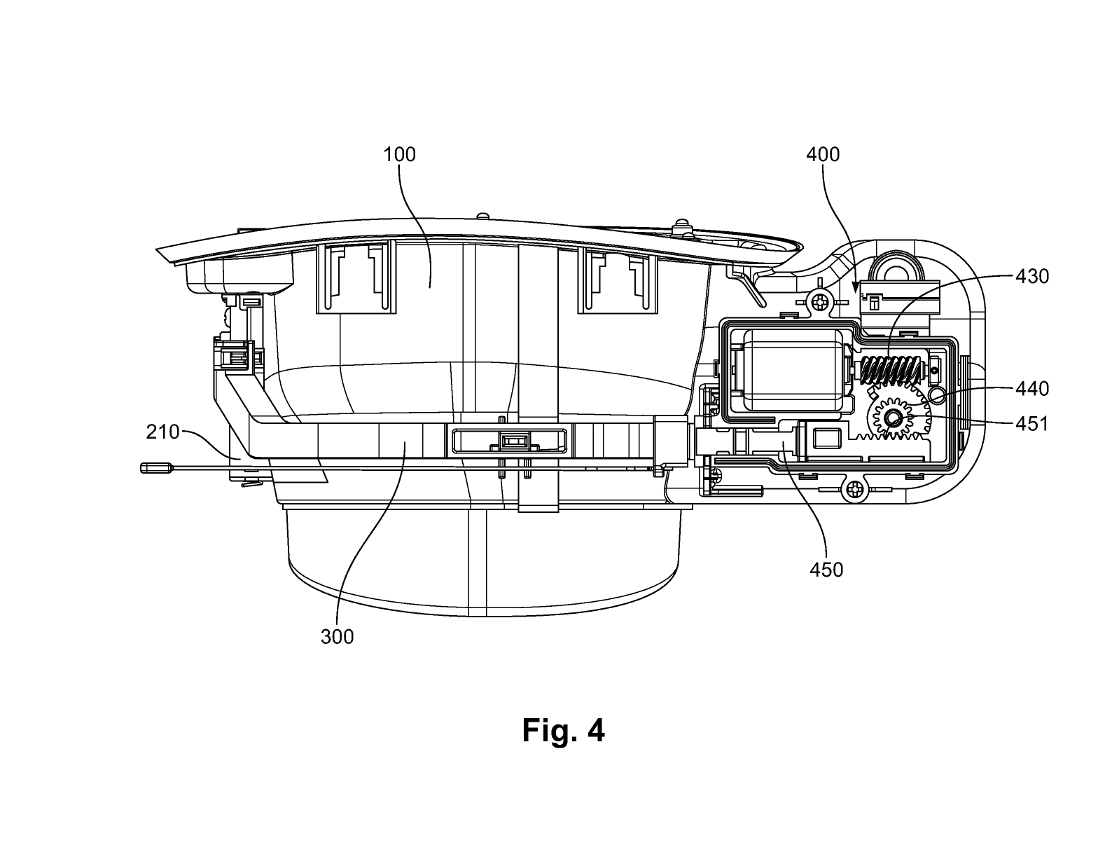

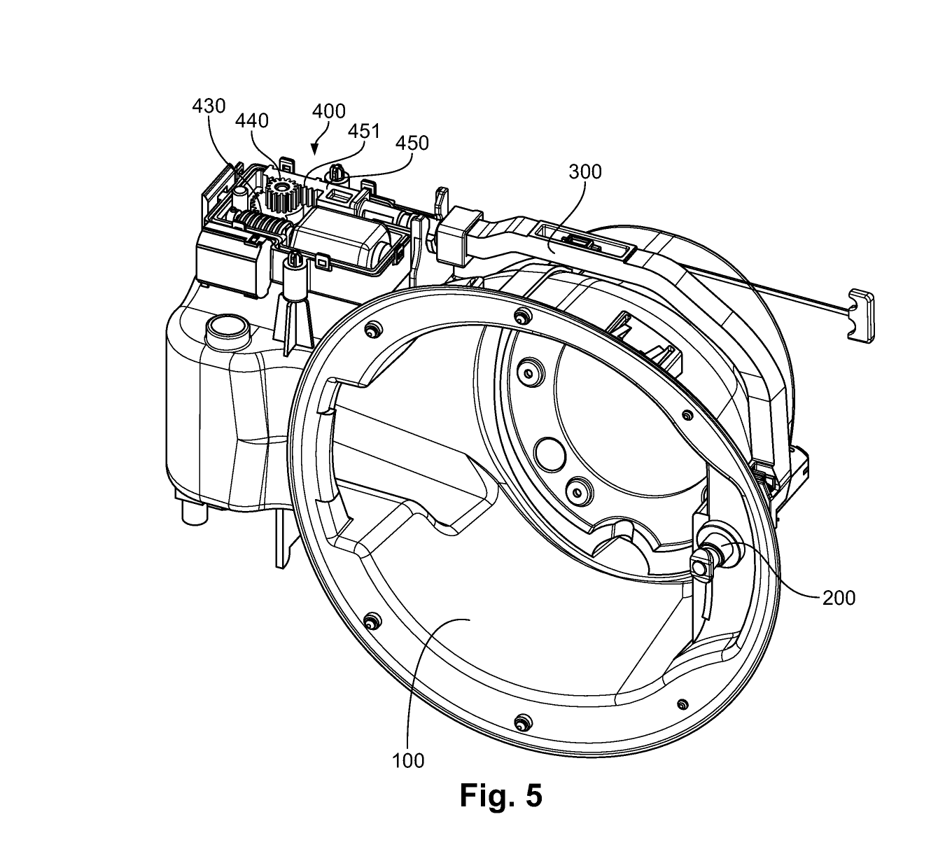

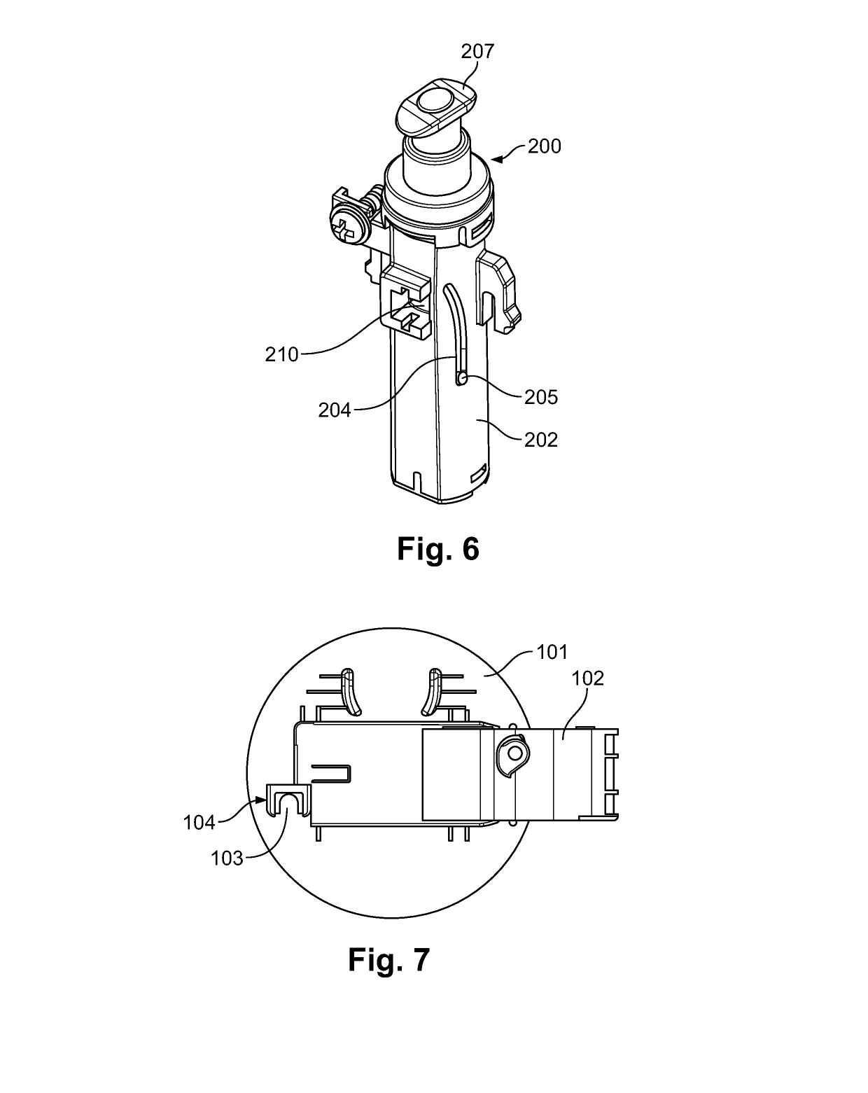

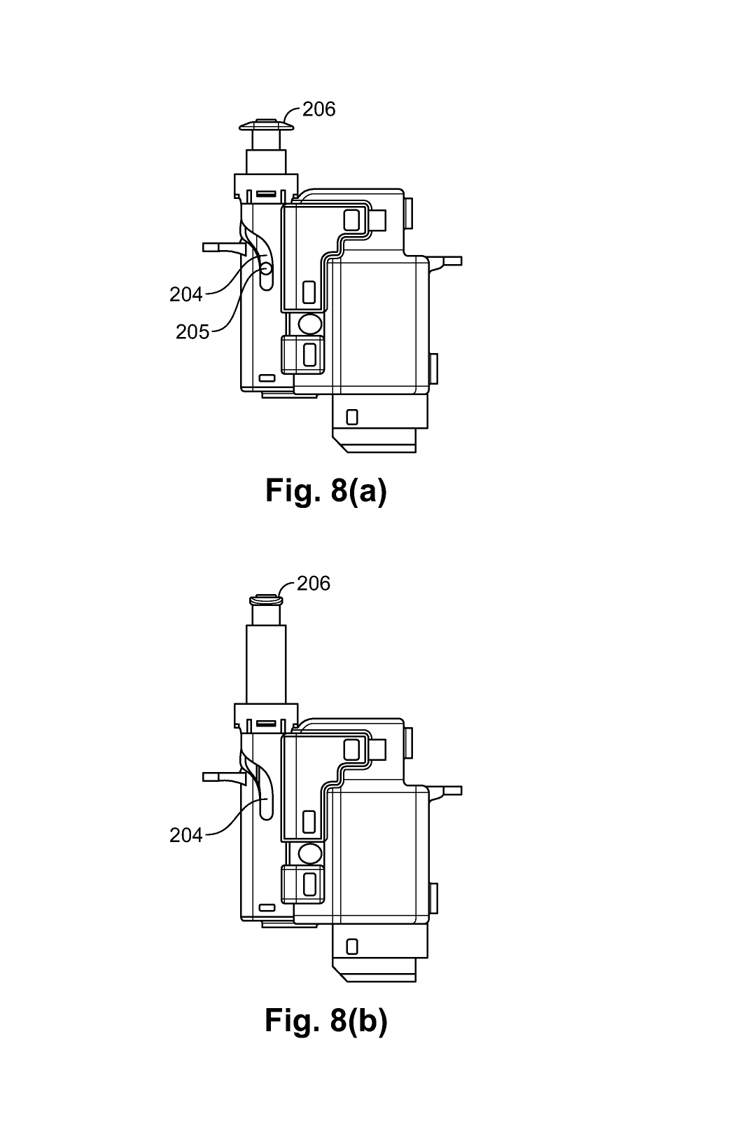

FIG. 2 is a perspective view for showing a device for opening and closing a fuel tank inlet cover for a vehicle according to the present invention, FIG. 3 is an exploded perspective view for showing the construction of the device for opening and closing the fuel tank inlet cover for the vehicle according to the present invention, FIG. 4 is a schematic view for showing the device for opening and closing the fuel tank inlet cover for the vehicle according to the present invention in a state in which the device is provided to a cap member, FIG. 5 is a perspective view for showing the device for opening and closing the fuel tank inlet cover for the vehicle according to the present invention in the state in which the device is provided to the cap member, FIG. 6 is a perspective view for showing a push-lift of the device for opening and closing a fuel tank inlet cover for a vehicle according to the present invention, FIG. 7 is a rear view of the inlet cover of the fuel tank, FIG. 8(a) is a side view of the push-lift in a lower position, and FIG. 8(b) is a side view of the push-lift in an upper position.

As shown in FIG. 2 to FIG. 8(b), the device for opening and closing the fuel tank inlet cover for the vehicle according to the present invention includes a cap member 100 having a fuel tank inlet of the vehicle, a cover 101 rotatably attached to the cap member 100 by a hinge 102, a push-lift 200 provided such that an upper end portion thereof is lifted or lowered with respect to a through hole 103 formed in a coupling rib 104 of the cover 101, so as to be inserted into or withdrawn from the through hole 103, a lock rod 300 for moving forwards or backwards to one side or the other side such that the push-lift 200 lowered is locked or unlocked, and an actuator 400 for enabling the lock rod 300 to move forward or backward in one side or the other side direction.

In particular, the hinge 102 for the cover 101 is attached to the cap member 100. At the rear side of the cover 101, the coupling rib 104 having the through hole 103 projects rearward, i.e. toward the cap member 100.

The push-lift 200 includes a lift member 201 slidably disposed in a cylindrical housing 202, in which springs 203 are disposed. The springs 203 urge the lift member 201 to protrude outside the cylindrical housing 202, and allow the lift member 201 to be located inside the cylindrical housing 202 in a compressed condition. This type of push-lift 200 is known as a push-push mechanism, and any type of push-push type push-lift 200 is used in the present invention.

The cylindrical housing 202 includes a curved slit 204, and the lift member 201 includes a projection 205 at a side portion thereof and a head 206 at an upper end. When the lift member 201 is assembled with the cylindrical housing 202, the projection 205 is located in the slit 204. Also, the head 206 has two lateral projections 207 which can engage the coupling rib 104.

Namely, when the lift member 201 is pushed down or located inside the cylindrical housing 202 together with the cover 101, the lateral projections 207 are oriented, as shown in FIGS. 6 and 8(a), wherein the lateral projections 207 can engage the coupling rib 104 of the cover 101. On the other hand, when the lift member 201 is in the upper position as shown in FIG. 8(b), the lateral projections 207 rotate 90 degrees with respect to the position as shown in FIG. 8(a), wherein the lateral projections 207 are simply disposed inside the through hole 103 and do not engage the coupling rib 104. Thus, in the upper position of the lift member 201, the cover 101 can be further opened by the hinge 104. In this way, when the cover 101 is closed, the lift member 201 rotates 90 degrees and is pushed into the cylindrical housing 202, wherein the lateral projections 207 engage the coupling rib 104. Thus, the cover 101 can not be opened.

Meanwhile, the actuator 400 includes a motor 420 provided to the inside of the case 410 so as to operate therein, a worm gear 430 for rotating in one or the other direction according to the operation direction of the motor 420, a worm wheel gear 440 for rotating in one or the other direction by the rotation force of the worm gear 430 so as to transmit the rotation force, and a lock gear 450 for receiving the rotation force of the worm gear 430 from the worm wheel gear 440 so as to move to one side or the other side, as shown in FIG. 3, such that the driving force of the motor 420 is accurately transmitted to the lock gear 450 through the worm gear 430 and the worm wheel gear 440.

Further, the lock gear 450 has a rack gear part 451 formed at one side portion so as to be engaged with the worm wheel gear 440 and a coupling part 452 formed at the other side end portion so as to be engaged with one side end portion of the lock rod 300, such that the rotation force transmitted through the worm wheel gear 440 is converted into linear motion through the rack gear part 451 of the lock rod 300 and thus the lock gear 450 moves forwards or backwards by momentum converted through the rack gear part 451.

Meanwhile, an insertion protrusion 310 is formed to be protruded on the other side end portion of the lock rod 300, wherein one side portion is coupled with the coupling part 452 of the lock gear 450, and an exit hole 210 is formed in the cylindrical housing 202 so as to carry out the locking or unlocking of the lift member 201 according to the insertion or withdrawal of the insertion protrusion 310. Therefore, the lock rod 300 simultaneously moves forward or backward according to the forward or backward movement of the lock gear 450 such that the insertion protrusion 310 is inserted into or withdrawn from the exit hole 210 and the lift member 201 is locked or unlocked according to the insertion or withdrawal of the insertion protrusion 310.

Incidentally, numeral 301 is a handle attached at one end to the lock rod 300 near the lock gear 450 to be used when the actuator 400 does not work. When the handle 301 is pulled, the lock rod 300 is moved to unlock the lift member 201. Thus, the cover 101 can be manually opened.

According to the present invention structured as above, the cover is provided to the cap member 100, which has the fuel tank inlet, so as to rotate by the hinge 102 during the assembling of the vehicle.

After coupling the cover 101 to the cap member 100, the push-lift 200 is provided such that the head of the push-lift 200 is engaged with or disengaged from the through hole 103, which is formed in the coupling rib 104, so as to be inserted into or withdrawn from the through hole 103.

After mounting the push-lift 200, the insertion protrusion 310 of the lock rod 300 is provided so as to be inserted into or withdrawn from the exit hole 210, wherein the insertion protrusion 310 of the lock rod 300 locks or unlocks the lift member 201 of the push-lift 200 while being inserted into or withdrawn from the exit hole 210. After mounting the insertion protrusion 310 of the lock rod 300 such that the insertion protrusion 310 of the lock rod 300 can be inserted into or withdrawn from the exit hole 210 of the cylindrical member 202 of the push-lift 200 as described above, the coupling part 452 formed at the other one side end portion of the lock gear 450 is coupled at the one side end portion of the lock rod 300.

After coupling the coupling part 452 formed at the other side end portion of the lock gear 450 to the lock rod 300, the actuator 400 is fixed at a position, where a mounting space for the actuator 400 is sufficiently secured.

Therefore, the assembling of the device for opening and closing a fuel tank inlet according to the present invention can be finished without the limitation of the mounting space by the actuator 400.

In the device for opening and closing the fuel tank inlet according to the present invention, where assembly is finished as above, if the cover 101 is to be opened, a switch (not shown) provided at a front section of a driver seat is operated. Thus, the motor 420, which is provided to the inside of the case 410 of the actuator so as to operate therein, rotates forwards, then the worm gear 430 rotates forward simultaneously with the forward rotation of the motor 420 and thus the worm wheel gear 440 rotates in one direction by the forward rotation of the worm gear such that the rack gear part 451 moves by the rotation of the worm wheel gear 440 and thus the lock gear 450 moves backwards.

Herein, since the lock gear 450 simultaneously moves backward by the backward movement of the rack gear part 451, the lock rod 300 also simultaneously moves backward by the backward movement of the lock gear 450 and the insertion protrusion 310 is withdrawn from the exit hole 210. In addition, the locking force to the lift member 201 is released by the withdrawal of the insertion protrusion 310 from the exit hole 210 such that the lift member 201 of the push-lift 200 can be pushed downward.

When the lift member 201 is pushed down through the cover 101, the lift member 201 can move out of the cylindrical housing 202 by the springs 203. As a result, the lift member 201 rotates 90 degrees, and the cover 101 is partially opened. Thus, the lateral projections 207 engaging the coupling rib 104 is withdrawn from the coupling rib 104. Accordingly, the locking force of the cover 101 is released, and the cover 101 can be further opened upwardly.

When the cover 101 is closed, the cover 101 is simply pushed down. As a result, the lift member 201 is rotated 90 degrees to engage the coupling rib 104 with the lateral projections 207, and the lift member 201 is pushed inside the cylindrical housing 202. Since the push lift 200 has the push-push mechanism, the lift member 201 with the cover 101 comes to the closed state.

In order to maintain the locked state of the cover 101, the switch is once again operated, so that the motor 420, which is provided to the inside of the case 410 of the actuator 400, is rotated backwards.

That is, when the worm gear 430 rotates backwards simultaneously with the backward rotation of the motor 420, then the worm wheel gear 440 rotates in the other direction by the backward rotation of the worm gear 430 such that the rack gear part 451 moves by the rotation of the worm wheel gear 440 and thus the lock gear 450 moves forwards.

Herein, when the lock gear 450 moves forward by the forward movement of the rack gear part 451, the lock rod 300 also moves forward by the forward movement of the lock gear 450 and the insertion protrusion 310 is inserted into the exit hole 210. Thus, the locking of the push-lift 200 is made by the insertion of the insertion protrusion 310 into the exit hole 210. Namely, the insertion protrusion 310 is inserted into a hole 208 of the lift member 201 through the exit hole 210. Thus, the lift member 201 is locked.

While the invention is explained with reference to the specific embodiment of the invention, the explanation is illustrative, and the invention is limited only by the appended claims.

What is claimed is:

1. A device for opening and closing a fuel tank inlet cover for a vehicle, comprising:
a cover provided to a cap member having a fuel tank inlet so as to rotate with respect to a hinge;
a push-lift provided such that an upper end portion thereof is lifted or lowered with respect to a through hole, which is formed in a coupling rib of the cover, so as to be inserted into or withdrawn from the through hole;
a lock rod for moving forward or backward to one side or the other side such that the push-lift is lifted or lowered so as to be locked or unlocked; and
an actuator for enabling the lock rod, to move forward or backward in one side or the other side direction.

2. The device for opening and closing the fuel tank inlet cover according to claim 1, wherein the actuator includes a motor provided to an inside of a case so as to operate therein, a worm gear for rotating in one side or the other side direction according to an operation direction of a motor, a worm wheel gear for rotating in one side or the other side direction by a rotation force of the worm gear so as to transmit the rotation force, and a lock gear for receiving the rotation force of the worm gear from the worm wheel gear so as to move to one side or the other side.

3. The device for opening and closing the fuel tank inlet cover according to claim 2, wherein the lock gear has a rack gear part formed at one side portion so as to be engaged with the worm wheel gear and a coupling part formed at the other side end portion so as to be engaged with one side end portion of the lock rod.

4. The device for opening and closing the fuel tank inlet cover according to claim 1, wherein an insertion protrusion is formed on the other side end portion of the lock rod, of which one side portion is coupled with the coupling part of the lock gear, and an exit hole is formed in the push-lift so as to carry out locking or unlocking according to insertion or withdrawal state of the insertion protrusion.
